(19) United States
(12) Patent Application Publication
(10) Pub. No.: US 2007/0103910 A1
(43) Pub. Date: May 10, 2007

(54) Light redirecting films having multiple layers and an adhesion layer

(75) Inventors: Cheryl J. Brickey, Greer, SC (US); Robert P. Bourdelais, Pittsford, NY (US); Richard D. Bomba, Rochester, NY (US); Michael R. Brickey, Greer, SC (US); Jon A. Hammerschmidt, Rochester, NY (US); Andre Kuziak, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/269,298

(22) Filed: Nov. 8, 2005

(51) Int. Cl. F21V 3/00

(52) U.S. Cl. 362/311

(57) ABSTRACT

The invention relates to an optical structure, comprising a polymer base layer, a thermoplastic polymer optical layer including top surface having a plurality of optical features; and an adhesion layer between the base layer and the optical layer, wherein the adhesive layer bonds to the base layer and to the optical layer.

### FIELD OF THE INVENTION

Embodiments of the present invention relate to light redirecting films for redirecting light from a light source toward a direction normal to the plane of the film.

### BACKGROUND OF THE INVENTION

Light redirecting films may be used in a variety of applications. Illustratively, light directing films may be used as part of a display or lighting device. Display and lighting devices may be based on a variety of technologies and can have very disparate applications. Regardless of the technology base or application, light-redirecting films may be used to improve the efficiency of the light transmitted from a light source to an output.

One technology that has gained attention in display technologies is liquid crystal (LC) technology. An LC display (LCD) includes a liquid crystal material that is modulated to provide a light-valve function. In many LCD applications, it is useful to improve the power efficiency. Increasing the power efficiency of an LCD (or other similar display) may be useful in improving the image quality of the display, among other benefits.

One way to improve the efficiency of LCDs is by recycling light using light redirecting film(s). The optics of a light redirecting film may be very specific and detailed. A light redirecting film may include a plurality of optical elements. These optical elements may be shaped and arranged to redirect light in an LCD, making the LCD more energy efficient. However, there may be secondary effects of a light redirecting film (e.g., moiré effects or a moiré interference pattern) that reduce the quality of the display. For example, light redirecting films that exhibit moiré effects may have undesirable non-uniform brightness across the LCD screen. This non-uniform brightness may be due to an ordered arrangement of optical elements in the light redirecting film.

The secondary effects of light redirecting films have been addressed by providing random patterns of optical elements. For example, U.S. patent to Wilson, et al. discloses a random pattern of optical elements that beneficially reduce interference and other effects that can reduce image quality in optical displays.

Light valve-based direct-lit optical displays continue to increase in size and application. This mandates larger optical films, including larger light redirecting layers. Unfortunately, these optical films are relatively thin and flexible, and by increasing their size (area) mechanical strain may cause deformation of the optical film. In turn, the mechanical deformation alters the optical properties of the film.

U.S. Pat. No. 5,919,551 (Cobb, Jr. et al) claims a linear array film with variable pitch peaks and/or grooves to reduce the visibility of moiré interference patterns. The pitch variations can be over groups of adjacent peaks and/or valleys or between adjacent pairs of peaks and/or valleys. While this varying of the pitch of the linear array elements does reduce moiré, the linear elements of the film still interact with the dot pattern on the backlight light guide and the electronics inside the liquid crystal section of the display. It would be desirable to break up the linear array of elements to reduce or eliminate this interaction.

U.S. Pat. No. 6,354,709 discloses a film with a linear array that varies in height along its ridgeline and the ridgeline also moves side to side. While the film does collimate light and its varying height along the ridgeline slightly reduces moiré, it would be desirable to have a film that significantly reduces the moiré of the film when used in a system while maintaining a moderately high on-axis gain.

US application 2001/0053075 (Parker et al.) discloses the use of integral features for the collimation of light. Surprisingly, it has been discovered that the careful selection of the design parameters of the integral features produce an unexpected balance between on-axis gain and moiré reduction for certain display configurations that was not anticipated by Parker et al.

U.S. Pat. No. 6,583,936 (Kaminsky et al) discloses a patterned roller for the micro-replication of light polymer diffusion lenses. The patterned roller is created by first bead blasting the roller with multiple sized particles, followed by a chroming process that creates micro-nodules. The manufacturing method for the roller is well suited for light diffusion lenses that are intended to diffuse incident light energy.

In addition, in order to improve the brightness of the image displayed, the number of light sources, or the power of the light sources, or both, continue to increase. This results in increased operating temperatures in optical displays, particularly in larger displays. These relatively high operating temperatures can result in the expansion and deformation of the optical films, including light redirecting films. Furthermore, higher temperatures can result in a loss of rigidity in the light redirecting film. The expansion or loss of rigidity of light redirecting films can alter the optical properties of the films and can interfere with the performance of the film in the optical display. Ultimately, this can adversely impact the performance of the optical display.

One option is to fabricate the optical film monolithically from a relatively thick material in an effort to provide a film having both the optical and mechanical properties that are desired. Unfortunately, forming optical features from relatively thick layers of suitable material for optical films is not desirable. One drawback is the poor replication of the extruded optical features formed from the material. Another drawback relates to the fabrication of the layer itself. As is known, extruding materials to have a relatively large thickness slows the extrusion process, thereby reducing the run-rate during manufacture. Among other considerations reduced run rates can decrease the output and increase the cost per item.

In addition to the shortcomings of known optical films, it may be beneficial to fabricate the optical features from certain materials that provide improved optical performance. Unfortunately, many of these materials are relatively expensive. Fabricating relatively thick optical films in an attempt to meet the demands of size and temperature stability may be cost-prohibitive. Thus, certain optical materials, while providing desirable optical properties, are precluded from consideration by the cost of the final product.

What is needed therefore is a light redirecting film and its method of manufacture that overcomes at least the drawbacks associated with known films described above.

### SUMMARY OF THE INVENTION

In accordance with an example embodiment, an optical structure includes a base layer; an optical layer including top surface having a plurality of optical features; and an adhesion layer between the base layer and the optical layer, wherein the adhesive bonds to the base layer and to the optical layer.

In accordance with another example embodiment, an optical display includes a light valve; a light source and a light redirecting layer, disposed in an optical path between the light source and the light valve. The light redirecting layer includes a base layer; an optical layer including top surface having a plurality of optical features; and an adhesion layer between the base layer and the optical layer, wherein the adhesive bonds to the base layer and to the optical layer.

In accordance with yet another example embodiment, a method of fabricating an optical structure includes providing a base; disposing an adhesion layer over the base; forming an optical layer over the adhesive; and forming a plurality of optical features in the optical layer.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a cross-sectional view of an optical film in accordance with an example embodiment.

FIG. 2 is a simplified schematic diagram of an apparatus for fabricating optical films in accordance with an example embodiment.

FIG. 3 is a cross-sectional view of an optical film in accordance with another example embodiment.

### DETAILED DESCRIPTION OF THE INVENTION

In the following detailed description, for purposes of explanation and not limitation, example embodiments disclosing specific details are set forth in order to provide a thorough understanding of the present teachings. However, it will be apparent to one having ordinary skill in the art having had the benefit of the present disclosure that other embodiments that depart from the specific details disclosed herein. Moreover, descriptions of well-known devices, methods, systems and materials may be omitted or only described briefly so as to not obscure the description of the example embodiments. Nonetheless, such devices, methods, systems and materials that are within the purview of one of ordinary skill in the art are contemplated for use in accordance with the example embodiments. Finally, wherever practical, like reference numerals refer to like features.

Light redirecting films of the example embodiments redistribute the light passing through the films such that the distribution of the light exiting the films is directed more normal to the surface of the films. These light redirecting films may be provided with ordered prismatic grooves, lenticular grooves, or pyramids on the light exit surface of the films which change the angle of the film/air interface for light rays exiting the films and cause the components of the incident light distribution traveling in a plane perpendicular to the refracting surfaces of the grooves to be redistributed in a direction more normal to the surface of the films. Such light redirecting films are used, for example, to improve brightness in liquid crystal displays (LCD), laptop computers, word processors, avionic displays, cell phones, PDAs and the like to make the displays look brighter.

The invention provides an adhesion layer allowing two dissimilar polymer materials to be joined into one structure. The use of dissimilar materials allows, for example, the optical structure to be both mechanical stable over a wide range of operating temperatures and yet have the desired optical properties, such as high light transmission, low coloration and high surface smoothness. The adhesion layer of the invention provides for excellent adhesion between pre-formed polymer sheet and a melt cast polymer. Prior art adhesion layers typically promote adhesion between a room temperature coated polymer and an oriented sheet, the invention adhesion layer provides excellent adhesion between a melt cast polymer such as polycarbonate with a temperatures substantially above the Tg of the polymer and an oriented preformed polymer sheet. The adhesion layer of the invention provides adhesion of the melt cast polymer layer at the time of polymer casting, allowing the melt cast polymer to be efficiently conveyed through a web based manufacturing process and provides sufficient adhesion to enable use in demanding electronic display applications such as LCD, organic light emitting diode (OLED) and flexible electro-wetting displays.

Additionally, the adhesion layer of the invention can be utilized to provide an antistatic layer, which reduces the build-up of static charge on a polymer film having two different materials. The build-up of static change on a optical; film has been shown to attract unwanted air-borne particulates which can create defects in display devices. Further, the adhesion layer of the invention can be utilized to provide a light diffusion means, allowing for diffusion of visible light entering the polymer optical elements. By adding a means for light diffusion in the adhesion layer, the film can have a dual function, eliminating the need for a separate light diffusion film.

It is noted that for the purpose of clarity of description, the light redirecting films of the example embodiments are often described in connection with liquid crystal (LC) systems. However, it is emphasized that this is merely an illustrative implementation of the light redirecting films of the example embodiments. In fact, the light redirecting films of the example embodiments may be used in other applications such as light valve-based displays and lighting applications, to mention only a few. As will be apparent to one of ordinary skill in the art having had the benefit of the present description, the light redirecting films may be implemented in other varied technologies.

The term as used herein, “transparent” means the ability to pass radiation without significant deviation or absorption. For this invention, “transparent” material is defined as a material that has a spectral transmission greater than 88%. The term “light” means visible light. The term “polymeric film” means a thin flexible film comprising polymers. The term “optical polymer” means homopolymers, co-polymers and polymer blends that are generally transparent. The term “optical features” means geometrical objects located on or near the surface of a web material that diffuse, turn, collimate, change the color or reflect transmitted or incident light. The term “adhesion layer” is a distinct continuous or patterned layer that functions to facilitate adhesion between two adjacent layers. The term “optical gain”, “on axis gain”, or “gain” means the ratio of output light intensity divided by input light intensity. Gain is used as a measure of efficiency of a collimating film and can be utilized to compare the performance different light collimating films.

Individual optical elements, in the context of an optical film, mean elements of well-defined shapes that are projections or depressions in the optical film. Individual optical elements are small relative to the length and width of an optical film. The term “curved surface” is used to indicate a three dimensional feature on a film that has curvature in at least one plane. “Wedge shaped features” is used to indicate an element that includes one or more sloping surfaces, and these surfaces may be combination of planar and curved surfaces.

The term “optical film” is used to indicate a thin polymer film that changes the nature of transmitted incident light. For example, a collimating optical film provide an optical gain (output/input) greater than 1.0. The term “polarization” means the restriction of the vibration in the transverse wave so that the vibration occurs in a single plane. The term “polarizer” means a material that polarizes incident visible light.

The terms “planar birefringence” and “birefringence” as used herein is the difference between the average refractive index in the film plane and the refractive index in the thickness direction. That is, the refractive index in the machine direction and the transverse direction are totaled, divided by two and then the refractive index in the thickness direction is subtracted from this value to yield the value of the planar birefringence. Refractive indices are measured using an Abbe-3L refractometer using the procedure set forth in Encyclopedia of Polymer Science & Engineering, Wiley, N.Y., 1988, pg. 261. The term “low birefringence” means a material that produces small changes in the polarization state of light and is confined to optical polymer web material that has a birefringence less than 0.01.

An amorphous polymer is a polymer that does not exhibit melting transitions in a standard thermo-gram generated by the differential scanning calorimetry (DSC) method. According to this method (well known to those skilled in the art), a small sample of the polymer (5-20 mg) is sealed in a small aluminum pan. The pan is then placed in a DSC apparatus (e.g., Perkin Elmer 7 Series Thermal Analysis System) and its thermal response is recorded by scanning at a rate of 10-20° C./min from room temperature up to 300° C. A distinct endothermic peak manifests melting. The absence of such peak indicates that the test polymer is functionally amorphous. A stepwise change in the thermo-gram represents the glass transition temperature of the polymer.

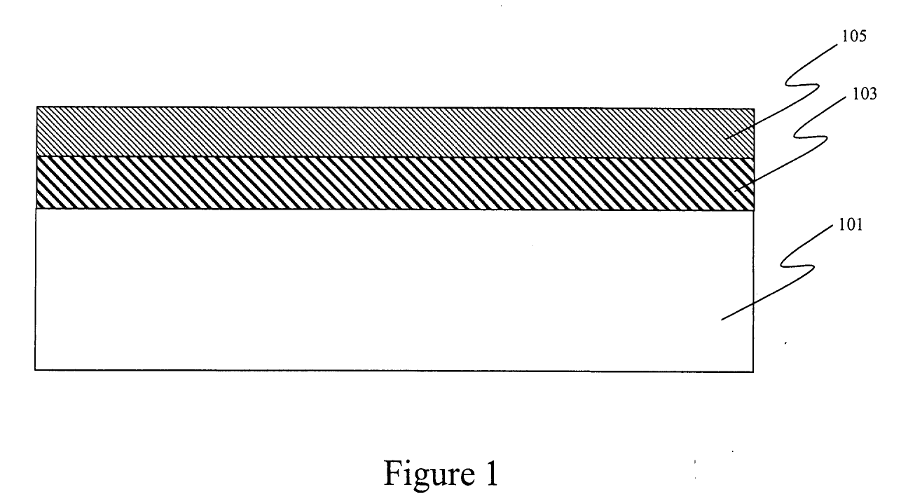

FIG. 1 is a cross-sectional view of an optical structure in accordance with an example embodiment. The optical structure may be a light-redirecting layer useful in lighting and display applications as noted previously. Further the optical structure may be diffusing, turning, or partially reflecting. The optical structure includes a base layer 101, an adhesion layer 103 and an optical layer 105.

The base layer 101 provides structural rigidity and thermal stability to the optical structure and is beneficial in preventing deformation of the optical structure when the optical structure has relatively large dimensions or when the optical structure is subject to high operating temperatures over time, or both. Accordingly, the base layer 101 is made of a material and has a thickness useful in preventing deformation due to stress and heat. Furthermore, the base layer 101, generally is substantially transmissive and have little if any coloration.

In an example embodiment, the base layer 101 is made of a material having a glass transition temperature (T_{g}) greater than approximately 70° C. and may have a T_{g} greater than approximately 150° C. By selecting a material having a relatively high T_{g} the optical structure is substantially free from warping or shrinkage when exposed to the operating temperatures of displays and lighting devices. As a result, the optical features remain properly oriented to function as designed. Further, by proving a base layer having a T_{g} greater than 70 degrees C., the base is less likely to warp or deform when melt cast polymer is cast upon the adhesion layer 103.

The base layer 101 must also be substantially immune to distortion due to stress because of its dimensions. As noted previously, as displays continue to increase in viewing area, the dimensions of the light redirecting layers also increase. With increased size, the stress placed on the optical structure increase and the structure may flex or bend. This can alter the optical properties of the optical structure and can deleteriously impact the optical quality of an image or performance of a light source. Accordingly, the base layer is selected to have a thickness and is made of a material that provides rigidity to the other layers of the optical structure. In an example embodiment, the base layer 101 has a thickness of approximately 250 μm and a modulus of elasticity of approximately 2 GPa.

In addition to desirable mechanical and thermal properties, the base layer may be relatively colorless and substantially transparent. In an example embodiment, the base layer 101 has a transmittivity greater than approximately 0.85. In a specific embodiment, the transmittivity of the base layer is greater than approximately 0.88 and may be greater than approximately 0.95. Moreover, in an example embodiment, the base layer 101 has a b* value of approximately −2.0 to approximately +2.0 measured on the Commission on Illumination (CIE) scale. Blue tinting agents such as dyes and pigments may be used to adjust the color of the optical element along the blue-yellow axis. An optical element having a slight blue tint is perceptually preferred by consumers to yellow optical elements as the “whites” in an LCD displayed image will tend to have a blue tint if the optical films utilized in the LCD display device have a blue tint.

Transparent base layers 101 are useful for optical structures that are utilized in light transmission mode. In other example embodiment, it may be beneficial for the base layer 101 to be substantially opaque. An opaque layer could provide high reflectivity, in the case of the base material having a high weight percent of a white pigment such as TiO₂ or BaSO₄, a base layer containing air voids or a base layer containing or having a layer containing reflective metal such as aluminum or silver. Opaque base layers can be utilized for back reflectors for LCD displays, diffusive mirrors or transflective elements.

In an example embodiment, the base layer 101 is a thermoplastic material. In specific embodiments, the base layer 101 may be polycarbonate, polystyrene, oriented polyester or polyethylene terephthalate (PET). These materials are merely illustrative. To wit, the base material may be other materials that provide the material properties noted previously. These materials include but are not limited to cellulose triacetate, polypropylene, PEN or PMMA.

The optical layer 105 may be an amorphous or semi-crystalline thermoplastic material useful in optical applications. The optical layer 105 is relatively thin, having a thickness on the order of approximately 25.0 μm. Illustratively, the thermoplastic material may be polycarbonate. In a specific embodiment, the optical layer 105 may be made of PET or PMMA. Polymers containing nano-particles of metal oxides for example may be utilized for the optical layer 105. These materials may be rather expensive, thereby prohibiting the fabrication of a light redirecting layer or similar structure as a monolithic structure having the suitable thickness for structural stability. However, because of the multi-layered structure with the substantially rigid base layer 101, the optical layer 105 is relatively thin and the benefits of these relatively expensive optical materials may be realized at a reasonable cost.

In a specific embodiment, the optical layer includes a plurality of optical features (not show in FIG. 1) in a random orientation. The optical features and their manufacture may be as described in: U.S. patent application Ser. No. 10/868,083, to Brickey and entitled “Thermoplastic Optical Features with High Apex Sharpness”, filed Jun. 15, 2004; and U.S. patent application Ser. No. 10/939,769 to Wilson and entitled “Randomized Patterns of Individual Optical Elements, filed Sep. 13, 2004. The referenced U.S. Patent Applications are assigned to the present assignee and are specifically incorporated herein by reference. It is emphasized that the optical features may be other than those described in the referenced applications.

Many of the materials that are useful for the base layer 101 because of desired mechanical and thermal properties will not adhere to certain materials that are useful as the optical layer, which are chosen for their optical properties. Therefore, due to the immiscibility of their respective materials and potentially low surface energies an optical structure comprised of just the base layer 101 and the optical layer 105 is not feasible with many materials.

The adhesion layer 103 usefully adheres to the base layer 101 and to the optical layer 105, and thereby provides an integral optical layer having the beneficial mechanical and thermal qualities of the base layer 101 and the beneficial optical qualities of the optical layer 105.

In an example embodiment, the adhesion layer 103 is disposed over the base layer 101 and polymer chains in the adhesion layer 101 intermingle with polymer chains in the base layer 101. Likewise, the polymer chains of the adhesion layer 103 intermingle with the polymer chains of the optical layer 105. This interaction creates sufficient forces to adhere the optical layer 105 to the base layer 101 via the adhesion layer.

The adhesion layer preferably has an adhesion to both the base layer 101 and the optical layer 105 of at least 400 grams per 35 mm width. Adhesion strength between the base layer and the adhesion layer or the optical layer and the adhesion layer is measured on an Instron gauge at 23° C. and 50% RH using a standard 180 degree peel test. The sample width is 35 mm and the peel length is 10 cm. Adhesion of at least 400 grams/35 mm is preferred because it has been found that providing an adhesion strength of at least 400 grams/35 mm adhesion prevents unwanted de-lamination of the optical layer 105 from the base layer 101 during a lifetime of use in an LCD display where temperature, temperature gradients and humidity are typically cycled during the lifetime of the device. Further 400 grams/35 mm adhesion strength is a sufficient adhesion to prevent de-lamination of the optical layer 105 from the base layer when there is a coefficient of thermal expansion (CTE) difference between the base layer 101 and the optical layer 105. The magnitude of the CTE difference will tend to increase unwanted inter-layer forces resulting in de-lamination of the layers. By providing sufficient adhesion between the layers, the de-lamination forces are overcome.

The selection of adhesion layer 103 depends on the materials selected for the base layer 101 and the optical layer 105. In an example embodiment, the adhesion layer 103 is a thermoplastic material of a different class of thermoplastics than base layer 101 and the optical layer 105. Illustratively, the adhesion layer may be acrylic, polyurethane, polyetherimide (PEI) or Poly(vinyl alcohol) PVA. More preferably, when the base layer comprises oriented PET and the optical layer comprises polycarbonate the adhesion layer is polyvinyl acetate-ethylene copolymer or Polyacrylonitrile-vinylidene chloride-acrylic acid copolymer with a monomer ratio of 15/79/6.

In another-preferred embodiment, the adhesion layer comprises an electrically conductive polymer. It has been found that some electrically conductive polymers also can function as an adhesion layer. By providing one layer that can both enhance adhesion between the base layer 101 and the optical layer 105, the electrically conductive material reduces unwanted static resulting from the composite structure and can reduce unwanted electrical fields in display devices such as LCD monitors. The electrically conductive material of the present invention is preferably coated from a coating composition comprising a polythiophene/polyanion composition containing an electrically conductive polythiophene with conjugated polymer backbone component and a polymeric polyanion component. A preferred polythiophene component for use in accordance with the present invention contains thiophene nuclei substituted with at least one alkoxy group, e.g., a C₁-C₁₂ alkoxy group or a —O(CH₂CH₂O)ₙCH₃ group, with n being 1 to 4, or where the thiophene nucleus is ring closed over two oxygen atoms with an alkylene group including such group in substituted form. Preferred polythiophenes for use in accordance with the present invention may be made up of structural units corresponding to the following general formula (I) 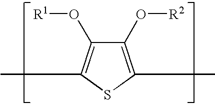
in which: each of R¹ and R² independently represents hydrogen or a C₁₋₄ alkyl group or together represent an optionally substituted C₁₋₄ alkylene group, preferably an ethylene group, an optionally alkyl-substituted methylene group, an optionally C₁₋₁₂ alkyl- or phenyl-substituted 1,2-ethylene group, 1,3-propylene group or 1,2-cyclohexylene group. The preparation of electrically conductive polythiophene/polyanion compositions and of aqueous dispersions of polythiophenes synthesized in the presence of polyanions, as well as the production of antistatic coatings from such dispersions is described in EP 0 440 957 (and corresponding U.S. Pat. No. 5,300,575), as well as, for example, in U.S. Pat. Nos. 5,312,681; 5,354,613; 5,370,981; 5,372,924; 5,391,472; 5,403,467; 5,443,944; and 5,575,898, the disclosures of which are incorporated by reference herein.

The preparation of an electrically conductive polythiophene in the presence of a polymeric polyanion compound may proceed, e.g., by oxidative polymerization of 3,4-dialkoxythiophenes or 3,4-alkylenedioxythiophenes according to the following general formula (II): 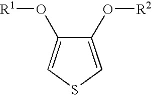
wherein: R¹ and R² are as defined in general formula (I), with oxidizing agents typically used for the oxidative polymerization of pyrrole and/or with oxygen or air in the presence of polyacids, preferably in aqueous medium containing optionally a certain amount of organic solvents, at temperatures of 0° to 1000° C. The polythiophenes get positive charges by the oxidative polymerization, the location and number of said charges is not determinable with certainty and therefore they are not mentioned in the general formula of the repeating units of the polythiophene polymer. When using air or oxygen as the oxidizing agent their introduction proceeds into a solution containing thiophene, polyacid, and optionally catalytic quantities of metal salts till the polymerization is complete. Oxidizing agents suitable for the oxidative polymerization of pyrrole are described, for example, in J. Am. Soc. 85, 454 (1963). Inexpensive and easy-to-handle oxidizing agents are preferred such as iron (III) salts, e.g. FeCl₃, Fe(ClO₄)₃ and the iron(III) salts of organic acids and inorganic acids containing organic residues, likewise H₂O₂, K₂Cr₂O₇, alkali or ammonium persulfates, alkali perborates, potassium permanganate and copper salts such as copper tetrafluoroborate. Theoretically, 2.25 equivalents of oxidizing agent per mol of thiophene are required for the oxidative polymerization thereof [ref. J. Polym. Sci. Part A, Polymer Chemistry, Vol. 26, p. 1287 (1988)].

For the polymerization, thiophenes corresponding to the above general formula (II), a polyacid and oxidizing agent may be dissolved or emulsified in an organic solvent or preferably in water and the resulting solution or emulsion is stirred at the envisaged polymerization temperature until the polymerization reaction is completed. The weight ratio of polythiophene polymer component to polymeric polyanion component(s) in the polythiophene/polyanion compositions employed in the present invention can vary widely, for example preferably from about 50/50 to 15/85. By that technique stable aqueous polythiophene/polyanion dispersions are obtained having a solids content of 0.5 to 55% by weight and preferably of 1 to 10% by weight. The polymerization time may be between a few minutes and 30 hours, depending on the size of the batch, the polymerization temperature and the kind of oxidizing agent. The stability of the obtained polythiophene/polyanion composition dispersion may be improved during and/or after the polymerization by the addition of dispersing agents, e.g. anionic surface active agents such as dodecyl sulfonate, alkylaryl polyether sulfonates described in U.S. Pat. No. 3,525,621. The size of the polymer particles in the dispersion is typically in the range of from 5 nm to 1 μm, preferably in the range of 40 to 400 nm.

Polyanions used in the synthesis of these electrically conducting polymers are the anions of polymeric carboxylic acids such as polyacrylic acids, polymethacrylic acids or polymaleic acids and polymeric sulfonic acids such as polystyrenesulfonic acids and polyvinylsulfonic acids, the polymeric sulfonic acids being those preferred for this invention. These polycarboxylic and polysulfonic acids may also be copolymers of vinylcarboxylic and vinylsulfonic acids with other polymerizable monomers such as the esters of acrylic acid and styrene. The anionic (acidic) polymers used in conjunction with the dispersed polythiophene polymer have preferably a content of anionic groups of more than 2% by weight with respect to said polymer compounds to ensure sufficient stability of the dispersion. The molecular weight of the polyacids providing the polyanions preferably is 1,000 to 2,000,000, particularly preferably 2,000 to 500,000. The polyacids or their alkali salts are commonly available, e.g., polystyrenesulfonic acids and polyacrylic acids, or they may be produced based on known methods. Instead of the free acids required for the formation of the electrically conducting polymers and polyanions, mixtures of alkali salts of polyacids and appropriate amounts of monoacids may also be used.

Preferred electrically-conductive polythiophene/polyanion polymer compositions for use in the present invention include 3,4-dialkoxy substituted polythiophene/poly(styrene sulfonate), with the most preferred electrically-conductive polythiophene/polyanion polymer composition being poly(3,4-ethylene dioxythiophene)/poly(styrene sulfonate), which is available commercially from Bayer Corporation as Baytron P. Other preferred electrically conductive polymers include poly(pyrrole styrene sulfonate) and poly(3,4-ethylene dioxypyrrole styrene sulfonate) as disclosed in U.S. Pat. Nos. 5,674,654; and 5,665,498; respectively.

In order to further increase the adhesion of the adhesion layer 103 to the base layer 101, the surface of the base layer 101 in contact with the adhesion layer 103 may be roughened to have scratches or grooves therein in either a random pattern or an ordered pattern. The roughened surface allows additional contact area between the base layer 101 and the adhesion layer 103 thereby increasing adhesion compared to an optically smooth base layer 101. a roughened surface with an roughness average between 0.8 and 4.0 micrometers has been found to provide an increase in adhesion layer 103 to base layer 101. At a surface roughness greater than 5.0 micrometers, the adhesion layer begins to have difficulty completely filing in the roughness features, creating small air voids. Of course, it is important that the grooves or scratches be relatively small so that optical affects such as diffraction and refraction are substantially avoided. In an example embodiment, prior to disposing the adhesion layer 103 over the base layer 101, the surface of the base layer may be brushed, sandblasted or etched using plasma. As described herein, this roughening may be carried out during the extrusion and feature forming process. Alternatively, the roughening may be carried out before the extrusion feature forming process, with the base layer 101 being roughened before further processing to form the optical structure.

As can be appreciated, the multi-layer optical structure includes optical interfaces between each layer. Accordingly, it is useful for the differential in the indices of refraction of the base layer 101, the adhesion layer 102 and the optical layer 103 be small if not insignificant to avoid reflective and refractive effects that can impair the function of the optical structure. For example, if the optical structure is a light redirecting layer, reflections and refractions at the interfaces of the layers can reduce the light output of the light-redirecting layer. In a specific embodiment, the differential in the indices of refraction (Δn) is less than approximately 0.1 is preferred.

In another preferred embodiment of the invention, the adhesion layer preferably comprises a means to diffuse light. By providing a means to diffuse light, the optical structure can both function as a light collimator and a diffuser thereby combining two functions into a single component. Further, an adhesion layer 103 having a low haze value between 10 and 30 and has been shown to high small defects in the optical element significantly decreasing the ability of a display consumer to detect defects. Preferred means for light diffusion is in the bulk of adhesion layer 103 such as reflective particles such as TiO2, nano-sized clay, glass beads, air voids, immiscible polymers and layered polymers having a different index of refraction.

Applied to the surface of the adhesion layer 103 may also be antireflection coatings comprising alternating layers if materials having alternating high and low indiccs of refraction for the purpose of reducing unwanted reflection from the optical structure. In another preferred embodiment, the surface of the adhesion layer adjacent the base layer 101 or adjacent the optical layer 105 may be transflective. A transflective surface is a surface having both transmission and reflective characteristics. An example of a transflective element would be a 400 to 500 angstrom deposition of aluminum that is approximately 50% transmissive and 50% reflective to visible light. Transflective coatings are useful for displays that are utilized in outdoor lighting conditions and use reflective sunlight to partially or fully illuminate a LCD display.

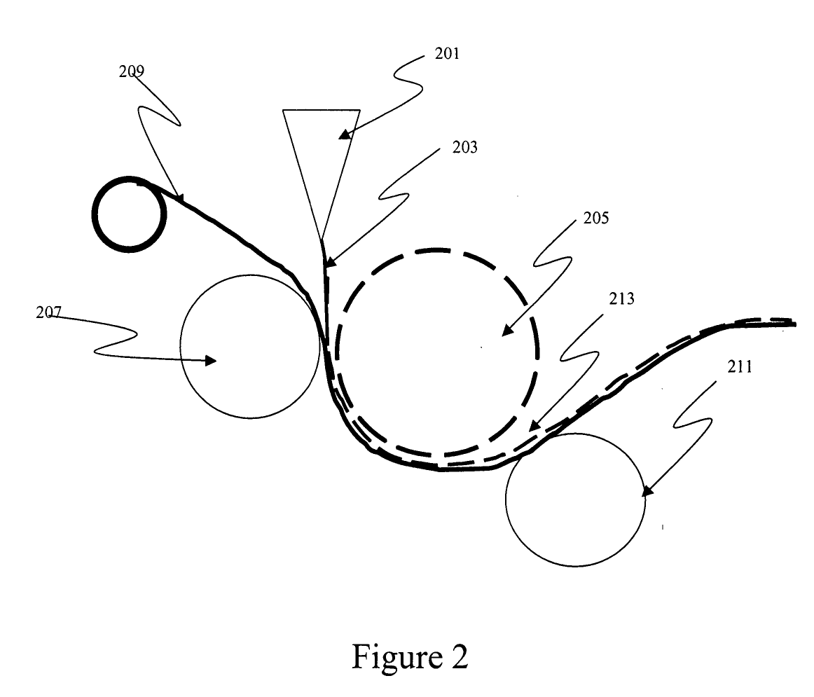

FIG. 2 is a simplified schematic diagram of an apparatus for fabricating an optical structure such as described in connection with FIG. 1. The apparatus includes an extruder 201, which extrudes a material 203. In a specific embodiment, the material 203 forms the optical layer 105 described previously in FIG. 1. The apparatus also includes a patterned roller 205 that forms the optical features in the optical layer 213. Additionally, the apparatus includes a pressure roller 207 that provides pressure to force material 203 into patterned roller 205 and stripping roller 211 that aids in the removal of material 203 from patterned roller 205.

In operation, a base layer 209 is forced between the pressure roller 207 and the patterned roller 205 with the extruded material 203. In an example embodiment, the base layer 209 is the base layer 101 described previously, with the adhesion layer 103 formed thereover. Moreover, the material 203 forms the optical layer 205, which includes optical features after passing between the patterned roller 205 and the pressure roller 207. Alternatively, the adhesion layer may be co-extruded with the material 203 at the extruder 201. Co-extrusion offers the benefit of two or more layers. The co-extruded adhesion layers can be selected to provide optimum adhesion to the base layer 101 and the optical layer 105 creating higher adhesion than a mono-layer. Accordingly, the co-extruded adhesion and optical layers are forced with the base layer between the pressure roller 207 and the patterned roller 205. This results in the adhesion of the base layer 101, the adhesion layer 103 and the optical layer 105, as well as the formation of the optical features on the optical layer 105. After passing between the pressure roller 207 and the patterned roller 205, a layer 213 is passed along a roller 211. In a specific embodiment, the layer 213 is an optical structure of the embodiments described in detail with respect to FIG. 1.

In an example embodiment, the adhesion layer is adhered to the base before the extrusion of the optical film and formation of the optical features. In a specific embodiment, the adhesion layer 103 may be coated onto the surface of the base layer 101. The coating process may be carried out by known solution coating methods or by known aqueous coating methods. After the coating is completed, the coated base layer is introduced as layer 209 for formation of the optical structure.

In another preferred embodiment, the adhesion layer 103 is patterned. A patterned adhesion layer has been found to increase bond strength as during formation of the optical layer, the optical layer polymer can flow between the patterned adhesion layer thereby effectively increasing surface area for bonding. An example of a patterned adhesion layer would be a simple repeating sine wave function that has a period of 50 micrometers and amplitude of 5 micrometers. Further, by patterning the adhesion layer 103 and providing an index of refraction difference between the adhesion layer 103 and the base layer 101 of at least 0.02, the geometry of the patterned adhesion layer can serve to provide a beneficial optical function such as light diffusion, or light collimation. For example, an adhesion layer patterned in a 90 degree prism geometry will is provide some collimation of incident light before the light has an opportunity to pass through the optical layer.

In a specific embodiment, layer 213 may be subjected to ultrasonic energy after passing through the rollers 205 and 207. Ultrasonic welding has been shown to increase the bond between the adhesion layer 103 and both the base layer 101 and the optical layer 105. Notably, the source ultrasonic energy (not shown) may be located near the end of the extruder 201 or at another point along the path of extrusion and feature formation. Ultrasonic energy typically originates at an ultrasonic horn having a frequency of between 20 and 60 Khz. An anvil surface located adjacent the base layer 101 allows for the ultrasonic energy to be converted into heat energy for further increase the bond strength between the base layer 101 and the adhesion layer 103.

In other illustrative embodiments, before being introduced between the pressure roller 207 and patterned layer 209, the layer 213 may be subjected to a corona discharge treatment, a plasma irradiation treatment or an infra-red radiation treatment in order to increase the adhesion of the base layer 101, the adhesion layer 103 and the optical layer 105. The discharge treatment and the plasma increase the surface roughness to increase the adhesion of the layer 209 to the material 203. In a specific embodiment, the layer 209 is the base layer 101 and the material 202 is the co-extrusion of the adhesion layer 103 and the optical layer 105. This surface roughness improves the adhesion of the adhesion layer 103 to the base layer 101. In another specific embodiment, the layer 209 includes the base layer 101 and the adhesion layer 103, disposed thereover; and the material 203 is the material for the optical layer 105. In this case the roughening of the adhesion layer increases the adhesion between the adhesion layer 103 and the optical layer 105.

IR treatment can be applied to layer 209 before its introduction between the rollers 205 and 207. This layer may be the base layer 101 or the base layer 101 with the adhesion layer 103, disposed thereover. The heating of layer 209 increases the intermingling of the polymer chains of the adhesion layer 103 and the optical layer 105 and the adhesion layer 103 and the base layer 101.

In another example embodiment, the base layer 101 and the adhesion layer may be co-extruded to form layer 209. Layer 209 may then be extruded with the material 203 (the optical layer) for formation of the optical structure.

The process of fabricating the optical features and of extruding layers of material is known. Details of the formation of optical features and of extrusion may be found in the above-referenced applications to Brickey and Wilson.

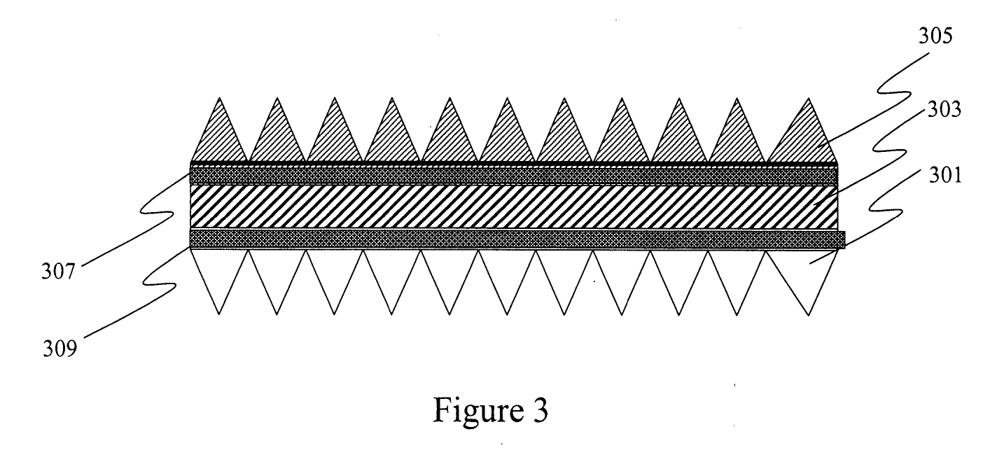

FIG. 3 is a cross-sectional view of an optical structure having optical features on both sides of the structure. This structure may be useful in optical displays and lighting applications as a light-redirecting layer. The

The optical structure includes a base layer 303 having optical features 305 and 301. The base layer 303 may be as described previously, providing beneficial mechanical and thermal characteristics. The optical structure also includes adhesion layers 307 and 309 as described previously. Optical features 305 and 301 are disposed over the adhesion layers 307 and 309. The optical features 305 and 301 may be complimentary in function such as light collimation or may have tow distinct functions such as light collimation and light diffusion. Optical features 305 and 301 may be in optical registration or be randomly positioned relative to each other.

While the adhesion layer of the invention is selected to provide adequate adhesion between the adhesion layer and both the base layer and the optical layer, in another preferred embodiment of the invention, the bond strength between base layer 101 and adhesion layer 103 is sufficiently low to allow for easy separation of the base layer 101 and the adhesion layer 103. Separation of the base layer from the adhesion layer and the optical layer allow for adhesion layer and base layer to be applied to a different base layer. The final chosen base layer material may not be readily adapted to polymer melt extrusion and pressure formation, therefore by separation of the base layer from the adhesion layer allows for subsequent re-application to a base layer. Examples of delicate base materials that might require reapplication include a rigid glass base, a polymer base having a Tg less than 50 degrees C. and a precision micro-patterned base.

Various optical layers, materials, and devices may also be applied to, or used in conjunction with, the films and devices of the present invention for specific applications. These include, but are not limited to, magnetic or magneto-optic coatings or films; liquid crystal panels, such as those used in display panels and privacy windows; photographic emulsions; fabrics; prismatic films, such as linear Fresnel lenses; brightness enhancement films; holographic films or images; embossable films; anti-tamper films or coatings; IR transparent film for low emissivity applications; release films or release coated paper; and polarizers or mirrors.

The invention may be used in conjunction with liquid crystal display devices, typical arrangements of which are described in the following. Liquid crystals (LC) are widely used for electronic displays. In these display systems, an LC layer is situated between a polarizer layer and an analyzer layer and has a director exhibiting an azimuthal twist through the layer with respect to the normal axis. The analyzer is oriented such that its absorbing axis is perpendicular to that of the polarizer. Incident light polarized by the polarizer passes through a liquid crystal cell is affected by the molecular orientation in the liquid crystal, which can be altered by the application of a voltage across the cell. By employing this principle, the transmission of light from an external source, including ambient light, can be controlled. The energy required to achieve this control is generally much less than that required for the luminescent materials used in other display types such as cathode ray tubes. Accordingly, LC technology is used for a number of applications, including but not limited to digital watches, calculators, portable computers, electronic games for which light weight, low power consumption and long operating life are important features.

Active-matrix liquid crystal displays (LCDs) use thin film transistors (TFTs) as a switching device for driving each liquid crystal pixel. These LCDs can display higher-definition images without cross talk because the individual liquid crystal pixels can be selectively driven. Optical mode interference (OMI) displays are liquid crystal displays, which are “normally white,” that is, light is transmitted through the display layers in the off state. Operational mode of LCD using the twisted nematic liquid crystal is roughly divided into a birefringence mode and an optical rotatory mode. “Film-compensated super-twisted nematic” (FSTN) LCDs are normally black, that is, light transmission is inhibited in the off state when no voltage is applied. OMI displays reportedly have faster response times and a broader operational temperature range.

In addition, the invention materials can be utilized in other display devices such as OLED and rear projection systems. Further, the invention material are useful for, but not limited to, improve the output of commercial and residential lighting systems, retro-reflective systems, solar cells, automobile lighting, traffic lighting and graphic art applications.

Illustrative embodiments have numerous advantages compared to current light redirecting films. In view of this disclosure it is noted that the various methods and devices described herein can be implemented in hardware and software. Further, the various methods and parameters are included by way of example only and not in any limiting sense. In view of this disclosure, those skilled in the art can implement the present teachings in determining their own techniques and needed equipment to affect these techniques, while remaining within the scope of the appended claims.

The following examples illustrate the practice of this invention. They are not intended to be exhaustive of all possible variations of the invention. Parts and percentages are by weight unless otherwise indicated.

### EXAMPLES

In this example, several polymer adhesion layers were utilized to provide adhesion between an amorphous patterned polycarbonate polymer layer and both a typical oriented PET base layer and a typical melt cast polycarbonate base layer. The patterned polycarbonate layer contained individual optical elements designed to collimate incident light typically utilized in LCD display devices to improve brightness of the LCD device. This example will demonstrate the utility and function of several different adhesion layer formulations. Further, this example will demonstrate the unique properties of a functioning adhesion layer.

Base Layers:

1. Typical transparent 175 micrometer thick biaxial oriented (stretch ratio 3×-by-3×) polyethylene terephthalate (PET) base layer
2. Typical transparent 175 micrometer thick polycarbonate (PC) base layer (Lexan TF2OQ)
   Adhesion Layers:
1. POLYMER 1—Airflex 100 HS (Air Products) polyvinyl acetate-ethylene copolymer latex emulsion having a Tg of 7 degrees C. and containing no surfactant
2. POLYMER 2—Airflex 4530 (Air Products), ethylene vinyl chloride polymer having a T_{g} of 29 degrees C.
3. POLYMER 3—Polyvinyl acetate having a Tg of 30 degrees C.
4. POLYMER 4—Polyacrylonitrile-vinylidene chloride-acrylic acid copolymer (15/79/6)

The adhesion layers were applied to both base layers (oriented PET and cast carbonate) utilizing a X-hopper coating technique and machine dried before being wound into a roll. Table 1 below provides a summary of the combinations.

TABLE 1

| Test | | | Solids lay-down |
|---|---|---|---|
| Condition | Base Layer | Adhesion layer | (grams/m2) |
| 1 | PET | POLYMER 1 | 22.4 |
| 2 | PC | POLYMER 1 | 5.3 |
| 3 | PC | POLYMER 1 | 22.4 |
| 4 | PC | POLYMER 1 | 68.0 |
| 5 | PET | POLYMER 2 | 20.2 |
| 6 | PC | POLYMER 2 | 4.2 |
| 7 | PC | POLYMER 2 | 20.2 |
| 8 | PC | POLYMER 2 | 62.0 |
| 9 | PET | POLYMER 3 | 8.0 |
| 10 | PC | POLYMER 3 | 4.0 |
| 11 | PC | POLYMER 3 | 8.0 |
| 12 | PC | POLYMER 3 | 41.5 |
| 13 | PET | POLYMER 4 | 20.0 |

The above base layers containing the adhesion layers listed in Table 1 above were utilized as a base for extrusion melt cast polycarbonate optical lenses useful for the collimation of visible, incident light. The above base layers containing the an adhesion layer were conveyed through a high pressure nip comprising a backing roller on one side and a heated (142 degrees C.) patterned nickel plated roller on the opposite side. The nickel-plated patterned roller contained individual curved cavities having a geometric size of 35 micrometers depth, 1200 micrometer length and a 90 degree apex angle. Melted Teijin AD-5503 carbonate (316 degrees C.) was applied between the adhesion layer coated base layers and the nickel-plated patterned roller. The thickness of the polycarbonate melt layer was approximately 100 micrometers. As the adhesion coated base layer was conveyed through the high-pressure nip at 15 meters/min, the polycarbonate lenses are formed in the cavities on the patterned roller and are adhered to the adhesion layer surface. The following cross section illustrates the basic structure of the example.

Polycarbonate formed collimation lenses
Adhesion layer
Base Layer

The adhesion of the melt cast polycarbonate lenses to the base layers was measured utilizing a standard 180-degree peel adhesion test. Peel force was measured at 23 degrees C. and 50% RH using a peel sample width of 35 mm. The measured peel force is expressed in units of grams force per 35 mm width. The peel adhesion test was performed after an incubation of 24 hours at 23 degrees C. and 50% RH. Table 2 below contains peel force results for the 13 samples in this example.

TABLE 2

| | | | Peel force |
|---|---|---|---|
| Test Condition | Base Layer | Adhesion layer | (grams/35 mm) |
| 1 | PET | POLYMER 1 | <200 |
| 2 | PC | POLYMER 1 | 1044 |
| 3 | PC | POLYMER 1 | 2008 |
| 4 | PC | POLYMER 1 | >2500 |
| 5 | PET | POLYMER 2 | <200 |
| 6 | PC | POLYMER 2 | <200 |
| 7 | PC | POLYMER 2 | <200 |
| 8 | PC | POLYMER 2 | <200 |
| 9 | PET | POLYMER 3 | <200 |
| 10 | PC | POLYMER 3 | <200 |
| 11 | PC | POLYMER 3 | <200 |
| 12 | PC | POLYMER 3 | <200 |
| 13 | PET | POLYMER 4 | >2500 |

As the data above clearly demonstrates, by providing an adhesion layer to the surface of either the PET base layer or a polycarbonate base layer, adhesion of the polycarbonate light collimation lenses was significantly improved as in the case of experimental samples 2, 3 and 13 compared to the other samples. In particular, POLYMER 1 created an excellent bond between the PC base and the melt extruded PC lenses. POLYMER 4 created excellent adhesion between the PET base and the melt extruded PC lenses. Further, the melt extruded polycarbonate lenses had very low adhesion to uncoated oriented PET and cast PC base layers. Adhesion of the polycarbonate lenses to the base layer is important in that the optical structure requires mechanical integrity for many of the contemplated uses, especially inclusion into display systems such as LCD displays. LCD display systems are challenged with a wide range of operation conditions for temperature and humidity that can cause unwanted de-lamination of composite polymer optical films. Further, the backlights contained in many LCD devices generate high temperatures and temperature gradients mechanically further stressing composite, multiple layered optical structures. By providing adhesion between the adhesion layer and both the base layer and optical structure layer greater than 400 grams/35 mm, the optical structure of the invention can both maintain integrity and function as an optical element.

While this example was directed at LCD display devices and light collimation, the invention materials may be utilized in other display devices including OLED, electro-wetting, CRT, projection screen and ink printed display systems. Additionally, the optical structure may also diffuse, transflect, refract, diffract or absorb visible or invisible light energy.

What is claimed is:

1. An optical structure, comprising:
a polymer base layer;
a thermoplastic polymer optical layer including top surface having a plurality of optical features; and
an adhesion layer between the base layer and the optical layer, wherein the adhesion layer bonds to the base layer and to the optical layer.

2. An optical structure as recited in claim 1, wherein the optical structure is a light redirecting layer and the optical features substantially collimate visible light.

3. An optical structure as recited in claim 1, wherein the base layer is a material having a glass transition temperature (T_{g}) that is greater than approximately 70° C.

4. An optical structure as recited in claim 3, wherein the T_{g} is greater than approximately 150° C.

5. An optical structure as recited in claim 1, wherein the base layer has a elastic modulus greater than approximately 2.0 GPa.

6. An optical structure as recited in claim 1, wherein the adhesive layer comprises at least two layers.

7. An optical structure as recited in claim 1, wherein the adhesion layer is patterned.

8. An optical structure as recited in claim 1, wherein the base layer has a light transmission at 550 nanometers that is greater than approximately 0.90.

9. An optical structure as recited in claim 1, wherein a material of the base is a thermoplastic.

10. An optical structure as recited in claim 1, wherein a material of the base layer is polyethylene terephthalate (PET) or polystyrene.

11. An optical structure as recited in claim 1, wherein the material of the base layer is polycarbonate.

12. An optical structure as recited in claim 1, wherein the material of the base layer is oriented polyester.

13. An optical structure as recited in claim 1, wherein adhesion between the optical layer and the base layer is at least 400 grams/35 mm sample width.

14. An optical structure as recited in claim 1, wherein the adhesive layer has a CIE *b value is in the range of approximately −2.0 to approximately +2.0.

15. An optical structure as recited in claim 1, wherein the material of the base has a CIE *b value is in the range of approximately −2.0 to approximately +2.0.

16. An optical structure as recited in claim 1, further comprising a plurality of random grooves in a surface of the base that is in contact with the adhesion layer.

17. An optical structure as recited in claim 1, wherein the adhesion layer is an acrylic polymer or polyurethane.

18. An optical structure as recited in claim 1, wherein the adhesion layer is polyvinyl acetate-ethylene copolymer or polyacrylonitrile-vinylidene chloride-acrylic acid copolymer.

19. An optical structure as recited in claim 1, wherein said adhesion layer comprises an electrically conductive polymer.

20. An optical structure as recited in claim 1, wherein each of the base layer, the adhesion layer and the optical layer has an index of refraction and a difference between any two of the indices of refraction is not greater than 0.1.

21. An optical structure as recited in claim 1, wherein the adhesion layer further comprises a means for visible light diffusion.

22. An optical structure as recited in claim 1, wherein the optical features comprises individual polycarbonate optical elements having an apex angle of 90 degrees, the adhesion layer comprises polyacrylonitrile-vinylidene chloride-acrylic acid copolymer, the base layer comprises oriented PET and further comprising a continuous layer of polycarbonate located on the side opposite the optical features.

23. An optical display, comprising:
a light valve;
a light source; and
a light redirecting layer disposed in an optical path between the light source and the light valve, wherein the light redirecting layer further comprises:
a polymer base layer;
a thermoplastic polymer optical layer including a top surface having a plurality of optical features; and
an adhesion layer between the base layer and the optical layer, wherein the adhesion layer bonds to the base layer and to the optical layer.

24. An optical display as recited in claim 23, wherein the optical layer substantially collimates light from the light source to the light valve.

25. An optical display as recited in claim 23, wherein the light valve is a liquid crystal device (LCD).

26. An optical display as recited in claim 23, wherein the base layer is a material having a glass transition temperature (T_{g}) that is greater than approximately 70° C.

27. An optical display as recited in claim 23, wherein the base layer has a Young's modulus greater than approximately 2.0 GPa.

28. An optical display as recited in claim 23, wherein the base layer has a light transmission at 550 nanometers that is greater than approximately 0.88.

29. An optical display as recited in claim 23, wherein the adhesive layer comprises polyvinyl acetate-ethylene copolymer or polyacrylonitrile-vinylidene chloride-acrylic acid copolymer.

30. An optical display as recited in claim 23, wherein the optical structure has a CIE *b value in the range of approximately −2.0 to approximately +2.0.

31. An optical display as recited in claim 23, wherein each of the base layer, the adhesion layer and the optical layer has an index of refraction and a difference between any two of the indices of refraction is not greater than 0.1.

32. A method of fabricating an optical structure, the method comprising:
providing a base;
disposing an adhesion layer over the base;
forming a thermoplastic optical layer over the adhesive; and
forming a plurality of optical features from the optical layer.

33. A method as recited in claim 32, wherein the forming the optical layer further comprises melt extruding the optical layer over the adhesion layer.

34. A method as recited in claim 32, wherein the disposing the adhesion layer further comprises coating the adhesion layer over the base.

35. A method as recited in claim 32, wherein the disposing the adhesion layer further comprises melt co-extruding the adhesion layer with the base layer.

36. A method as recited in claim 32, wherein the disposing the adhesion layer further comprises melt co-extruding the adhesion layer and thermoplastic optical layer.

37. A method as recited in claim 32, further comprising, before the disposing, roughening a surface of the base that is in contact with the adhesion layer.
